(19) United States
(12) Patent Application Publication
(10) Pub. No.: US 2002/0038232 A1
(43) Pub. Date: Mar. 28, 2002

(54) Automated management system

(76) Inventor: Koichi Nihira, Chiyoda (JP)

Correspondence Address: STAAS & HALSEY LLP, 700 11TH STREET, NW, SUITE 500, WASHINGTON, DC, 20001, US

(21) Appl. No.: 09/817,256

(22) Filed: Mar. 27, 2001

(30) Foreign Application Priority Data
Sep. 28, 2000 (JP) 2000-297132

(51) Int. Cl. G06F 17/60

(52) U.S. Cl. 705/8

(57) ABSTRACT

A management system is provided for managing operations of a plurality of customer service devices by utilizing an administrative system, a maintenance system and a management device, the devices and systems being connected to each other through a network. The management device includes an information registering unit registering management information about the customer service devices supplied from the administrative system; an action creating/registering unit creating a plurality of actions to operate the customer service devices, and registering the plurality of actions, based on the management information, each action corresponding to each condition of the customer service devices; and an action selecting/executing unit selecting an action in accordance with condition information corresponding to a condition of the customer service devices, and taking the action with respect to the customer service devices, the condition information being supplied from the administrative system and the maintenance system. Accordingly, a part of customer-service-device management that needs human operations may be omitted, thereby achieving accurate information transmission, a decrease in a loss time, and a cost reduction.

### BACKGROUND OF THE INVENTION

1. Field of the Invention

The present invention relates to a management method, a management device, a recording medium storing a management program and a management system. More particularly, the present invention relates to a management method, a management device, a recording medium storing a management program and a management system for collectively managing management information about a plurality of customer service devices and for managing operations of the plurality of customer service devices.

2. Description of the Related Art

Financial institutions or the like use expert agencies such as monitoring service companies, maintenance companies, security companies, system maintenance companies, etc., and delegate the maintenance and management of ATMs (Automated Teller machines) and CDs (Cash Dispensers) used by customers. This is because the operation of these machines involves cash, and, also, because expert knowledge and experience are required to deal with troubles and satisfy customers. Monitoring service companies monitor operations of ATMs. Maintenance companies attend to cash maintenance, which involves replenishing ATMs with cash and collecting cash from the ATMs. Security companies insure security of ATMs by monitoring the ATMs and the installations thereof to detect a malfunction and a breach of security. Maintenance companies perform duties of system maintenance by supplying various expendables and taking care of hardware.

In order to operate and manage ATMs, a financial institution operating the ATMs, for instance, assigns a person in charge of managing operations of the ATMs. This person instructs monitoring service, maintenance, security and system maintenance companies separately by telephone or facsimile (Fax) based on his or her judgment. Additionally, the person in charge of managing the operations of the ATMs receives reports regarding the ATMs from the monitoring service, maintenance, security and system maintenance companies through telephone or facsimile, and works on a report-specific basis by using the management table.

In the above-described system for managing the ATMs, the person in charge of managing the ATMs needs to separately instruct the monitoring service, maintenance, security and system maintenance companies based on the reported information about the ATMs indicating detection of a malfunction or the like. Additionally, the person needs to receive reports from the monitoring service, maintenance, security and system maintenance companies through telephone or facsimile, and needs to work on each report individually. Consequently, the burden on each person in charge of managing ATMs is undesirably heavy.

Additionally, in a case in which an abnormal condition is detected at an ATM, the first priority is to minimize inconvenience of customers. Accordingly, each financial institution needs to keep agencies having experience and expert knowledge on hand, and thus has difficulties in reducing the type of work that requires the staff to respond. Consequently, financial institutions have difficulty reducing time loss and preventing miscommunication during such type of work that requires the staff's intervention, and also have difficult cutting costs by reducing the amount of such type of work.

### SUMMARY OF THE INVENTION

Accordingly, it is a general object of the present invention to provide a management method, a management device, a recording medium storing a management program and a management system. A more particular object of the present invention is to provide a management method, a management device, a recording medium storing a management program and a management system for reducing human operations, thereby achieving accurate information transmission, a decrease in a loss time, and a cost reduction.

The above-described object of the present invention is achieved by a method of collectively managing management information about a plurality of customer service devices, and managing operations of the plurality of customer service devices based on the management information, the method comprising the steps of registering the management information; creating a plurality of actions to operate each customer service device, based on the management information, each action corresponding to a condition of the each customer service device; registering the plurality of actions; selecting an action in accordance with supplied condition information corresponding to the condition of the each customer service device; and taking the action with respect to the each customer service device.

Accordingly, a part of customer-service-device management that needs human operations may be omitted, thereby achieving accurate information transmission, a decrease in a loss time, and a cost reduction.

Other objects, features and advantages of the present invention will become more apparent from the following detailed description when read in conjunction with the accompanying drawings.

### BRIEF DESCRIPTION OF THE DRAWINGS

FIG. 1 is a diagram showing a management system, according to a first embodiment of the present invention;

FIG. 2 is a flowchart showing a process to set a standard pattern, according to a second embodiment of the present invention;

FIG. 3 is a diagram showing contract management information;

FIG. 4 is a diagram showing customer-service-device management information;

FIG. 5 is a diagram showing processes to create a contract management database and a customer-service-device management database, according to a third embodiment of the present invention;

FIG. 6 is a diagram showing a process to create the standard pattern, according to a fourth embodiment of the present invention;

FIG. 7 is a diagram showing a device/management pattern table;

FIG. 8 is a diagram showing a management pattern/action list tale;

FIG. 9 is a diagram showing a customer-service-device individual condition/instruction condition management database (an individual condition/instruction condition management database);

FIG. 10 is a flowchart showing a management process of a customer service device performed by a gateway apparatus, according to a fifth embodiment of the present invention;

FIG. 11 is a flowchart showing a collective decision process performed by the gateway apparatus, according to a sixth embodiment of the present invention;

FIG. 12 is a flowchart showing an overall decision process performed by the gateway apparatus, according to a seventh embodiment of the present invention;

FIG. 13 is a flowchart showing another overall decision process performed by the gateway apparatus, according to an eighth embodiment of the present invention; and

FIG. 14 is a block diagram showing a structure of a computer system as the gateway apparatus, according to a ninth embodiment of the present invention.

### DESCRIPTION OF THE PREFERRED EMBODIMENTS

A description will now be given of preferred embodiments of the present invention, with reference to the accompanying drawings. It should be noted that the description will given of an ATM (Automated Teller Machine) management system controlled by a financial institution as an embodiment of a management system. However, the embodiment is not limited to the ATM management system, and can be any management systems managing customer service devices used by customers.

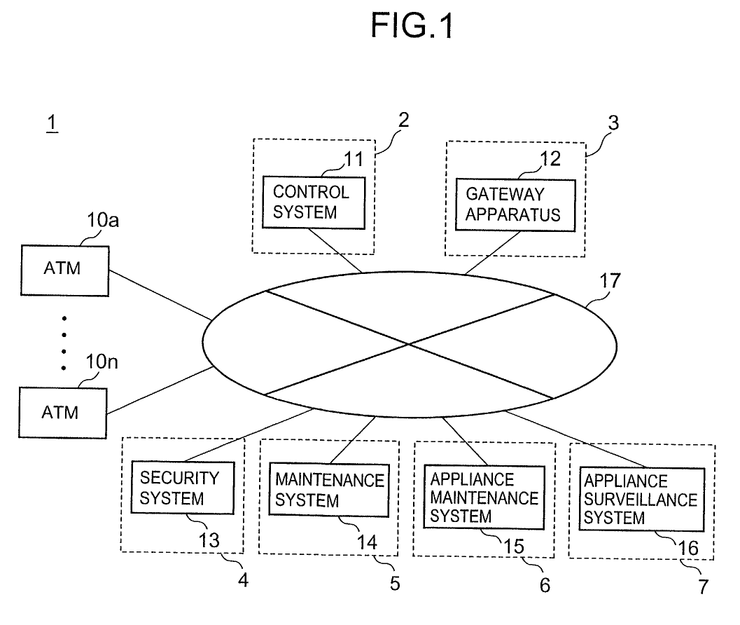

FIG. 1 is a diagram showing a management system, according to a first embodiment of the present invention. A management system 1 shown in FIG. 1 includes an ATM 10a through an ATM 10n, a control system 11, a gateway apparatus 12, a security system 13, a maintenance system 14, an appliance maintenance system 15, and an appliance surveillance system 16, each being connected to a network 17. The control system 11 is provided at a financial institution 2, for instance. The gateway apparatus 12 is provided at a management company 3 executing management of the ATMs 10a through 10n for the financial institution 2. Additionally, the security system 13, the maintenance system 14, the appliance maintenance system 15 and the appliance surveillance system 16 are provided respectively at a security company 4, a maintenance company 5, a system maintenance company 6 and a monitoring service company 7. The network 17 is, for example, the Internet, a VPN (Virtual Private Network), or a public communication network. The numbers of the financial institution 2, the management company 3, the security company 4, the maintenance company 5, the system maintenance company 6 and the monitoring service company 7 may be more than one in the management system 1 shown in FIG. 1. Additionally, the network 17 may include more than one network to increase network security.

The ATMs 10a through 10n are embodiments of customer service devices, and are installed in financial institutions, any stores other than the financial institutions, self-service shops, or on the street. Each ATM accepts an instruction from a customer such as withdrawal or deposit of money, and executes the instruction, within the limits of functions controlled by a menu. The ATM supplies an instruction inputted by a customer through the network 17 to the control system 11 of the financial institution 2, and performs a process order corresponding to the instruction inputted by the customer, the process order being supplied from the control system 11.

The control system 11 used by the financial institution 2 performs business operations of the financial institution 2, and includes functions to control processes performed by the ATMs 10a through 10n. The control system 11, at least, supplies a process order corresponding to an instruction from a customer to the ATMs 10a through 10n, and stores management information and contract information for controlling the ATMs. Additionally, the management system 1 needs to include duties such as a security duty, a maintenance duty regarding cash, a maintenance duty regarding a system, and a surveillance duty monitoring operating conditions of the ATMS, for managing the ATMS smoothly. Thus, the financial institution 2 entrusts each duty to the security company 4, the maintenance company 5, the system maintenance company 6 and the monitoring service company 7, as the need arises.

The management company (outsourcing company) 3 executing management of the ATMs 10a through 10n for the financial institution 2 obtains all the information regarding the ATMs 10a through 10n. The gateway apparatus 12 provided at the management company 3 determines a duty necessary to be carried out, according to the information regarding the ATMs 10a through 10n. If the management company 3 is entrusted with the duty, the management company 3 directly performs the duty. If a company other than the management company 3 is entrusted with the duty, the management company 3 instructs the company to perform the duty. Additionally, the gateway apparatus 12 receives information regarding a progress on processing the duty and a result of processing the duty from the company, and manages information about progresses and results of all the duties. Subsequently, the gateway apparatus 12 supplies the information about progresses and results of all the duties to the financial institution 2. As a result, the financial institution 2 does not need to manage the information about progresses and results of all the duties, and can utilize information designed to be supplied fast and to have high quality. Additionally, the gateway apparatus 12 can modify or convert information received from or to be transmitted to the network 17, in order to intermediate between the control system 11, the security system 13, the maintenance system 14, the appliance maintenance system 15 and the appliance surveillance system 16, and also can handle an increase in the number of financial institutions and diversification of contents of entrustment.

The security company 4 performs a security duty of the ATMs 10a through 10n and structures including the ATMs for detecting abnormal conditions of the ATMs and preventing crimes. The maintenance company 5 performs a maintenance duty regarding cash such as replenishment and collection of the cash. The system maintenance company 6 performs a maintenance duty regarding systems of the ATMs. Additionally, the monitoring service company 7 performs a surveillance duty monitoring operating and control conditions of the ATMs. The security system 13, the maintenance system 14, the appliance maintenance system 15 and the appliance surveillance system 16 receive instructions to perform duties from the gateway apparatus 12 as well as supply information about progresses and results of the duties to the gateway apparatus 12. Additionally, in a case of receiving information regarding the ATMs 10a through 10n, the security system 13, the maintenance system 14, the appliance maintenance system 15 and the appliance surveillance system 16 supply the information to the gateway apparatus 12.

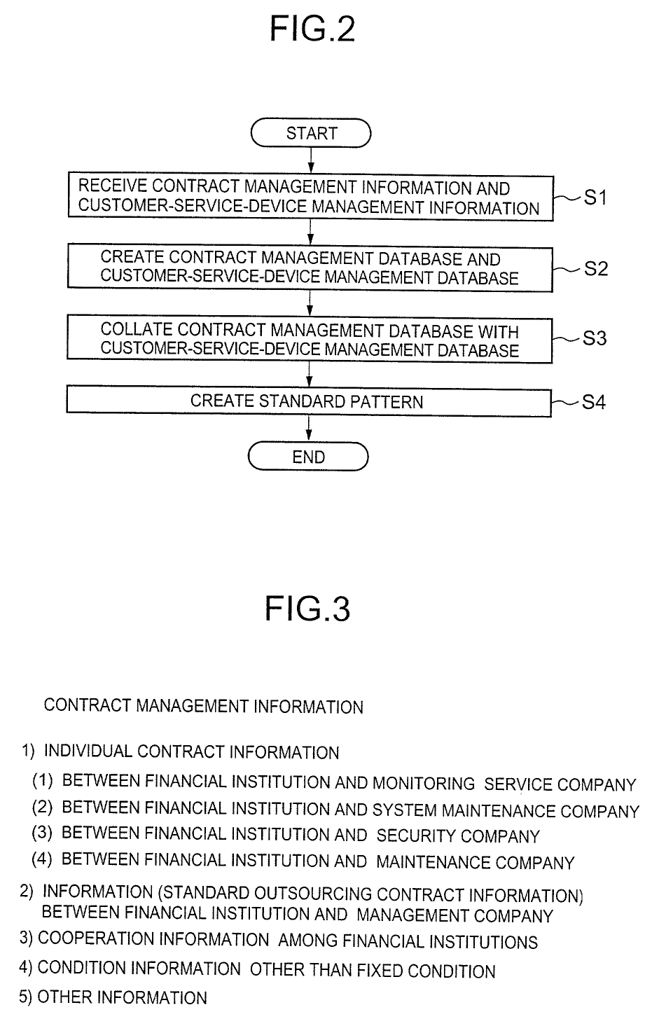

A detailed description will now be given of the management system 1, focusing on processes performed by the gateway apparatus 12, with reference to the figures. FIG. 2 is a flowchart showing a process to set a standard pattern, according to a second embodiment of the present invention. The standard pattern is a pattern of actions taken to deal with conditions, situations, and requirements of the ATMs 10a through 10n, and is set by following contract information. The conditions, situations, and requirements of the ATMS 10a through 10n will be called events, hereinafter.

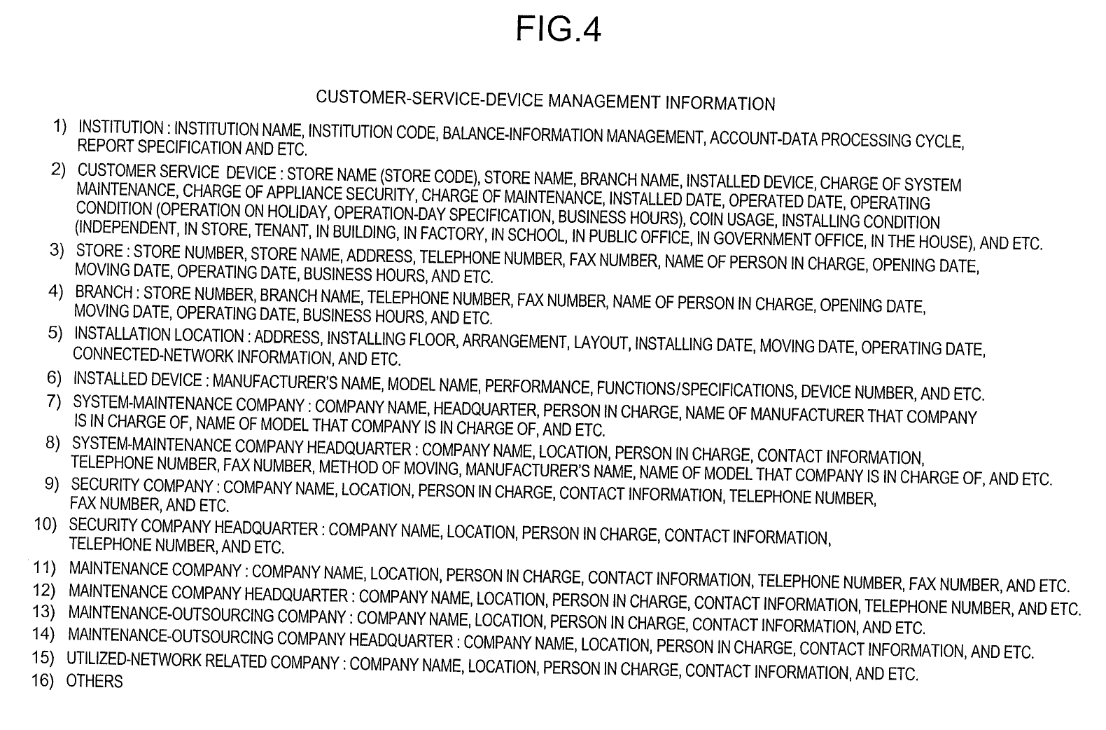

At a step S1 shown in FIG. 2, the management company 3 collectively entrusted with management of the ATMs 10a through 10n is supplied with contract management information shown in FIG. 3 and customer-service-device management information shown in FIG. 4 from the financial institution 2 in a document format or a data format, by following an outsourcing contract with the financial institution 2. In a case in which the management company 3 is supplied with the contract management information and the customer-service-device management information as a document, a person in charge at the management company 3 inputs the contract management information and the customer-service-device management information to the gateway apparatus 12. On the other hand, in a case in which the management company 3 is supplied with the contract management information and the customer-service-device management information as data, the gateway apparatus 12 reads the data from a recording medium such as a floppy disk, or receives the data through the network 17.

FIG. 3 is a diagram showing contract management information. Additionally, FIG. 4 is a diagram showing customer-service-device management information. The contract management information shown in FIG. 3 includes individual contract information, information (outsourcing contract information) between the financial institution 2 and the management company 3, cooperation information among financial institutions, and condition information other than a fixed condition.

The individual contract information includes information about contents of a contract between the financial institution 2 and the monitoring service company 7, contents of a contract between the financial institution 2 and the system maintenance company 6, contents of a contract between the financial institution 2 and the security company 4, and contents of a contract between the financial institution 2 and the maintenance company 5. Each contract may include a plurality of contents. For instance, in a case in which the management system 1 includes a plurality of monitoring service companies entrusted with a surveillance duty, a plurality of contents are set for the contract between the financial institution 2 and the monitoring service companies. Additionally, if types of entrusted duties increase, the individual contract information further includes contents of a contract corresponding to an added duty.

The contract information between the financial institution 2 and the management company 3 includes contents of an outsourcing contract, for example. The management system 1 can outsource management of the ATMs 10a through 10n. The cooperation information among financial institutions includes contents of cooperation among financial institutions, for instance, information about an ATM transaction fee. The condition information other than a fixed condition includes a condition used for determining execution of a secondary contract, and is used in a case in which a regular company entrusted with handling of troubles cannot handle troubles occurring collectively, and thus a delay in handling of the troubles is expected.

On the other hand, the customer-service-device management information includes institution information, customer-service-device information, store information, branch information, installation location information, installed-device information, system-maintenance company information, system-maintenance company headquarter information, security company information, security company headquarter information, maintenance company information, maintenance company headquarter information, maintenance outsourcing company information, maintenance outsourcing company headquarter information, and utilized-network related company information.

The institution information is information regarding the financial institution 2, and includes, for instance, information about an institution name, an institution code, balance-information management, an account-data processing cycle, and a report specification. The customer-service-device information is information regarding the ATMs 10a through 10n, and includes, for instance, information about a store number (a store code), a store name, a branch name, an installed device, a charge of system maintenance, a charge of appliance security, a charge of maintenance, an installed date, an operated date, an operating condition, a coin usage (used/not used), and an installing condition. The store information includes, for instance, information about a store number, a store name, an address, a telephone number, a FAX number, a name of a person in charge, an opening date, a moving date, and business hours.

Additionally, the branch information includes, for instance, information about a store number, a branch name, a telephone number, a FAX number, a name of a person in charge, an opening date, a moving date, an operating date, and business hours. The installation location information includes, for instance, information about an address, an installing floor, an arrangement, a layout, an installing date, a moving date, an operating date, and connected-network information. The installed-device information is information regarding the ATMs 10a through 10n, and includes, for instance, information about a manufacturer's name, a model name, performance, functions/specifications, and a device number.

Additionally, the system-maintenance company information, the system-maintenance company headquarter information, the security company information, the security company headquarter information, the maintenance company information, the maintenance company headquarter information, the maintenance outsourcing company information, the maintenance outsourcing company headquarter information, and the utilized-network related company information is information regarding companies entrusted with various duties of the management system 1.

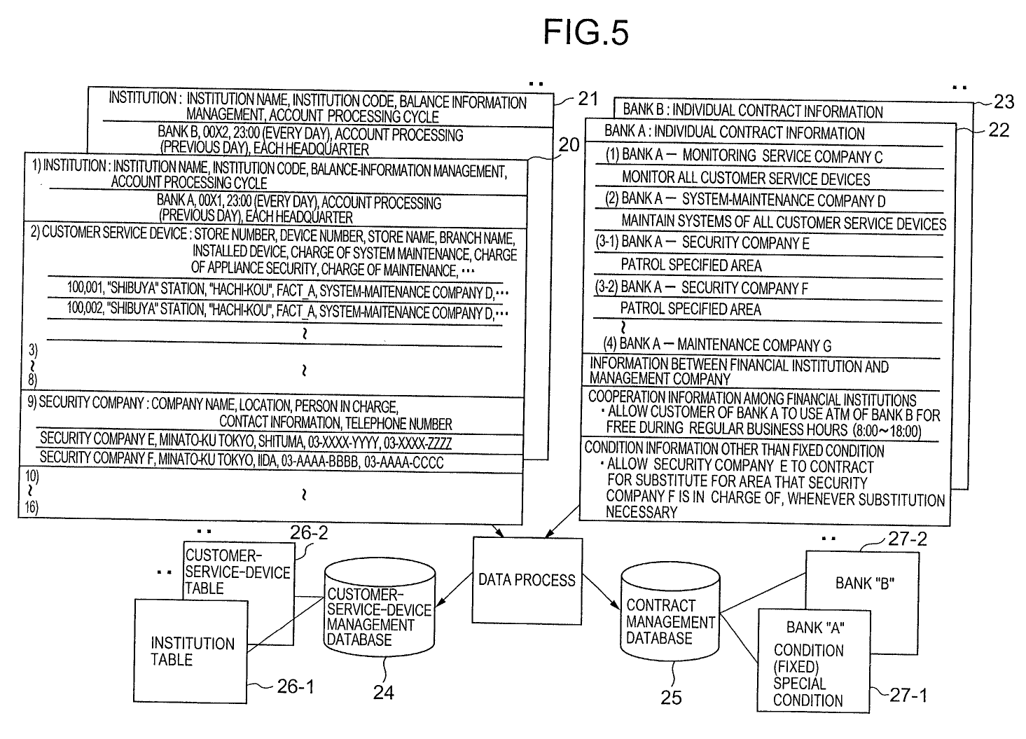

After receiving the contract management information shown in FIG. 3 and the customer-service-device management information shown in FIG. 4, the gateway apparatus 12 proceeds from the step S1 to a step S2 shown in FIG. 2. The gateway apparatus, then, creates a contract management database (DB) and a customer-service-device management database, based on the contract management information and the customer-service-device management information. FIG. 5 is a diagram showing processes to create the contract management database and the customer-service-device management database, according to a third embodiment of the present invention. Contract management information and customer-service-device management information shown in FIG. 5 only includes information necessary for explaining the processes, and a part of information unnecessary for the explanation is omitted.

The gateway apparatus 12 carries out data processes on customer-service-device management information 20 supplied from a bank A and customer-service-device management information 21 supplied from a bank B, thereby creating a customer-service-device management database 24 including, for instance, an institution table 26-1 and a customer-service-device table 26-2. The institution table 26-1 is created in accordance with institution information of the customer-service-device management information 20 and 21 supplied respectively from the bank A and the bank B, the institution information including, for instance, an institution name, an institution code, balance-information management, and an account-data processing cycle. The customer-service-device table 26-2 is created in accordance with customer-service-device information of the customer-service-device management information 20 and 21, the customer-service-device information including, for instance, a store number, a device number, a store name, a branch name, an installed device, a charge of system maintenance, a charge of appliance security and a charge of maintenance.

The customer-service-device management database 24 further includes a store table, a branch table, an installation location table, an installed device table, a system-maintenance company table, a system-maintenance company headquarter table, a security company table, a security company headquarter table, a maintenance company table, a maintenance company headquarter table, a maintenance-outsourcing company table, a maintenance-outsourcing company headquarter table, and a utilized-network related company.

Additionally, the gateway apparatus 12 carries out data processes on contract management information 22 supplied from the bank A and contract management information 23 supplied from the bank B, thereby creating contract management database 25 including, for instance, a contract management table 27-1 for the bank A and a contract management table 27-2 for the bank B. Each of the contract management tables 27-1 and 27-2 includes, for instance, individual contract information, information between a financial institution and a management company, cooperation information among financial institutions, and condition (specialized condition) information other than a fixed condition.

The contract management table 27-1 I created in accordance with the contract management information 22 of the bank A, such as the individual contract information, the information between a financial institution and a management company, the cooperation information among financial institutions, and the condition (specialized condition) information other than a fixed condition. Consequently, the contract management table 27-1 shown in FIG. 5 includes contents of a contract made between the bank A and a monitoring service company C to make the monitoring service company C to monitor all the customer service devices, and contents of a contract made between the bank A and a system maintenance company D to make the system maintenance company D to maintain systems of all the customer service devices. Additionally, since the bank A entrusts an appliance security duty to security companies E and F, the contract management table 27-1 includes contents of contracts made between the bank A and the security company E, and between the bank A and the security company F, to patrol a specified area.

Additionally, the contract management table 27-1 includes contents of an outsourcing contract made between the bank A and a management company G, and a contract made between the bank A and the bank B to allow a customer of the bank A to use an ATM of the bank B for free during regular business hours (8:00-18:00). Furthermore, the contract management table 27-1 includes contents of a contract (a special contract) made among the bank A, the security company E and the security company F to allow the security company E to contract for a substitute for an area that the security company F is in charge of, whenever the substitute is necessary.

The gateway apparatus 12 proceeds to a step S3 from the step S2 shown in FIG. 2, and confirms contents of the customer-service-device management database 24 and the contract management database 25 by collating the customer-service-device management database 24 with the contract management database 25. Additionally, the gateway apparatus 12 sets a link between the customer-service-device management database 24 and the contract management database 25. Subsequently, the gateway apparatus 12 proceeds to a step S4, and creates a standard pattern by utilizing information stored in the customer-service-device management database 24 and the contract management database 25.

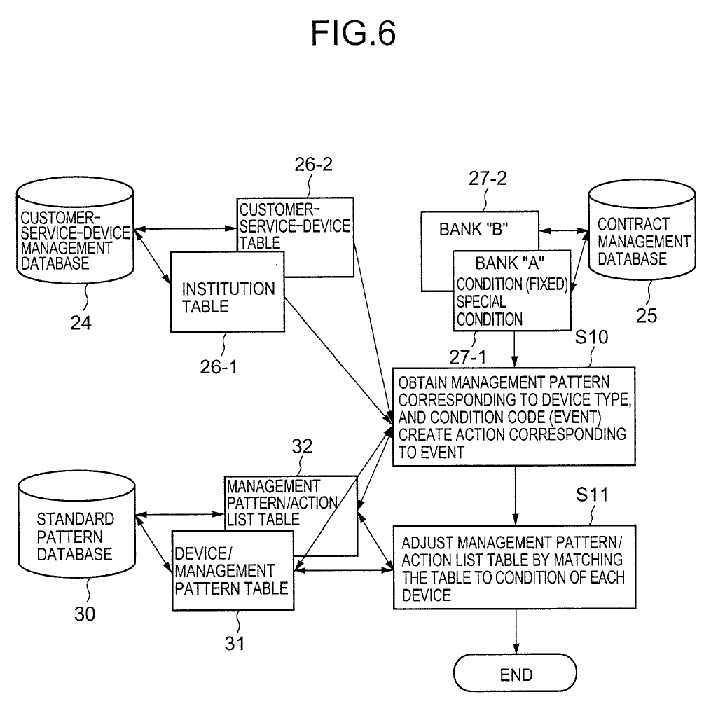

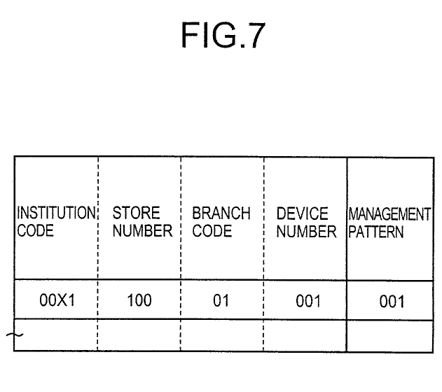

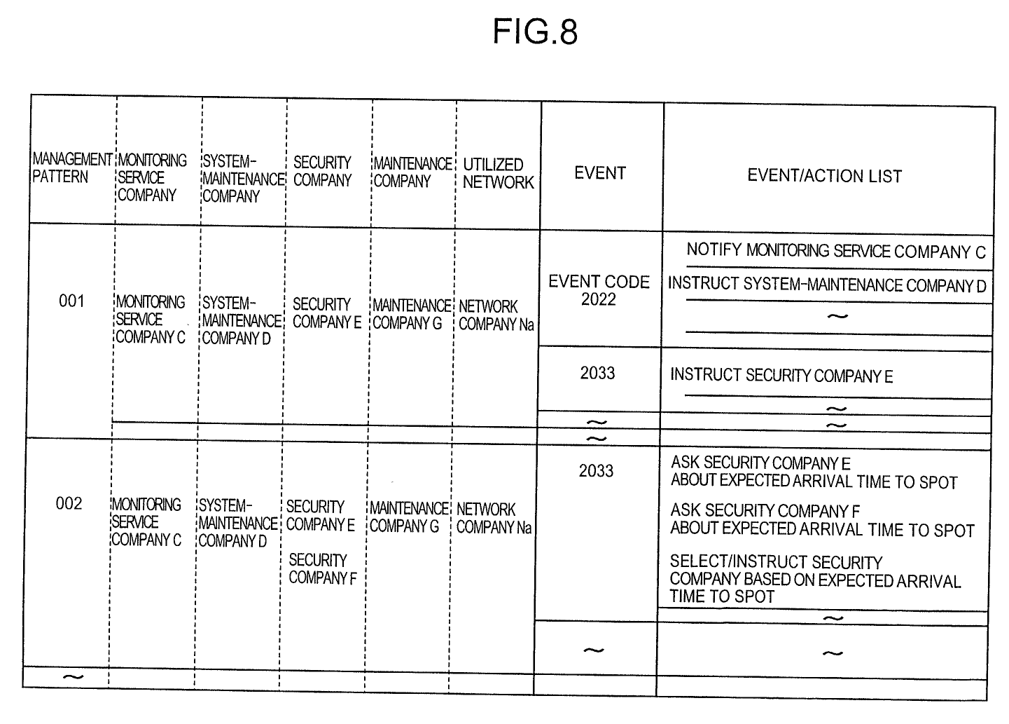

FIG. 6 is a diagram showing a process to create a standard pattern, according to a fourth embodiment of the present invention. The gateway apparatus 12 initially reads necessary information from the customer-service-device management database 24 and the contract management database 25 to set actions, to deal with events of the ATMs 10a through 10n by following the contract management tables 27-1 and 27-2 included in the contract management database 25. At a step S10 shown in FIG. 6, the gateway apparatus 12 classifies customer service devices, for instance, by types of installed devices, and sets management patterns corresponding to the classified customer service devices. Subsequently, the gateway apparatus 12 selects an event for each of the set management patterns, and then creates actions corresponding to the management patterns and events. The gateway apparatus 12 creates a device/management pattern table 31 shown in FIG. 7 and a management pattern/action list table 32 shown in FIG. 8, based on the management patterns, events and actions, which have been set previously. Subsequently, the gateway apparatus 12 stores the device/management pattern table 31 and the management pattern/action list table 32 in a standard pattern database (DB) 30.

FIG. 7 is a diagram showing the device/management pattern table 31. FIG. 8 is a diagram showing the management pattern/action list tale 32. The device/management pattern table 31 shown in FIG. 7 includes an institution code, a store number, a branch code, a device number, and a management pattern. The institution code is a code used for identifying an institution such as the financial institution 2, and is read from the institution table 26-1, as shown in FIG. 6. For instance, an institution code “00X1” indicates the bank A. The store number is a number used for identifying a store of the financial institution 2, and is read from the customer-service-device table 26-2. For instance, a store number “100” indicates a store located in front of the Shibuya station. The branch code is a code used for identifying a branch of the financial institution 2. The device number is a number used for identifying a customer service device installed by the financial institution 2, and is read from the customer-service-device table 26-2.

The management pattern is an identification number set corresponding to information such as a type of a customer service device. The management pattern is set in accordance with installed device information included in the customer-service-device table 26-2, for instance, in order to deal with a case in which duties necessary for managing customer service devices are different from each other depending on a type of each customer service device. However, the management pattern may be set corresponding to information other than a type of a customer service device.

The management pattern/action list table 32 shown in FIG. 8 includes a management pattern, a monitoring service company, a system maintenance company, a security company, a maintenance company, a utilized network, an event and an event/action list. The management pattern included in the management pattern/action list table 32 corresponds to the management pattern included in the device/management pattern table 31. The monitoring service company is a company entrusted with a surveillance duty to monitor an operating condition of a customer service device corresponding to the management pattern. A name of the monitoring service company is read from the contract management table 27-1, for example. The monitoring service company C is assigned as the monitoring service company included in the management pattern/action list table 32 shown in FIG. 8. The system maintenance company is a company entrusted with a maintenance duty regarding a system of a customer service device corresponding to the management pattern, and is read from the contract management table 27-1, for example. The system maintenance company D is assigned as the system maintenance company included in the management pattern/action list table 32 shown in FIG. 8. Similarly, each of the security company, the maintenance company, the utilized network included in the management pattern/action list table 32 is assigned with a company entrusted with a fixed duty of a customer service device corresponding to the management pattern.

The event included in the management pattern/action list table 32 is a code used for identifying conditions, situations, and requirements of a customer service device. For example, an event code “2022” indicates a situation in which a power of the customer service device is cut off. An event code “2033” indicates a situation in which a trespasser exists in a building. Multiple event codes may be set as the event included in the table 32. For instance, the event code 2022 may follow the event code 2033. The event/action list is a list of actions corresponding to events, the actions including methods and instructions set in detail for satisfying contents of a contract set in a table such as the contract management table 27-1. For example, actions including notification to the monitoring service company C and instruction to the system-maintenance company D are set for a case in which the event “2022” occurs at a customer service device corresponding to a management pattern “001”.

Additionally, the security companies E and F are assigned as security companies corresponding to a management pattern “002”, in the case in which the contract management table 27-1 includes contents of the contract (the special contract) made among the bank A, the security company E and the security company F to allow the security company E to contract for a substitute for an area that the security company F is in charge of, whenever the substitute is necessary. Actions are set for a case in which the event “2033” occurs at a customer service device corresponding to the management pattern “002”, the actions including notification to the security company E, notification to the security company F, and selection/instruction of a security company according to an arrival time to a spot.

In the case in which the event “2033” indicating existence of a trespasser in a building has occurred, the gateway apparatus 12 asks the security companies E and F about expected arrival time to the spot, based on the contract made among the bank A, the security company E and the security company F. Subsequently, each of the security companies E and F notifies the gateway apparatus 12 about the expected arrival time to the spot. The gateway apparatus 12 selects a security company whose expected arrival time is shorter than the other, and gives instructions to the selected security company. As described above, the management pattern/action list table 32 can deal with various contents of contracts including the special tripartite contract.

The gateway apparatus 12 proceeds to a step S11 from the step S10, as shown in FIG. 6. At the step S1, the gateway apparatus 12 adjusts the management pattern/action list table 32 to match a condition of each customer service device. Alternatively, a person in charge of the gateway apparatus 12 in the management company 3 can adjust the management pattern/action list table 32 to match various conditions by operating the gateway apparatus 12. Accordingly, the gateway apparatus 12 can carry out management of customer service devices such as the ATMs 10a through 10n by matching the management to various conditions, thereby enabling diverse outsourcing contracts.

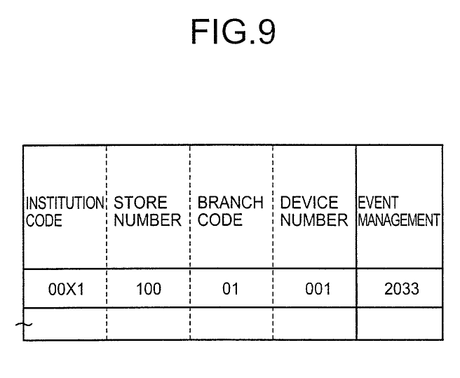

A description will now be given of a database included in the gateway apparatus 12. The gateway apparatus 12 includes a customer-service-device individual condition/instruction condition management database shown FIG. 9, an ATM balance information database, and an account processing information database, in addition to the customer-service-device management database 24, the contract management database 25, and the standard pattern database 30. The ATM balance information database includes information about an ATM balance, and other information. The account processing information database includes account processing information to be supplied to a financial institution possessing an ATM, for instance. FIG. 9 is a diagram showing a customer-service-device individual condition/instruction condition management database (an individual condition/instruction condition management database). The individual condition/instruction condition management database shown in FIG. 9 includes an institution code, a store number, a branch code, a device number, event management, and the like. A description will be omitted of information such as the institution code, the store number, the branch code, and the device number included in the individual condition/instruction condition management database, since they are the same as the institution code, the store number, the branch code, and the device number included in the device/management pattern table 31.

The event management is for recoding an event code of an event occurred at a customer service device, and is determined by data supplied from the control system 11, the security system 13, the appliance surveillance system 16, and the like. Accordingly, even in a case in which information indicating an event “a trespasser exists” is supplied from the security company 4 to the gateway apparatus 12 after instructing a maintenance duty regarding cash to the maintenance company 5 by the gateway apparatus 12, the gateway apparatus 12 can expect the trespasser is a person who is in charge of a customer service device and works at the maintenance company 5, by recording the event occurred at the customer service device to the event management. Additionally, in a case in which the gateway apparatus 12 has received information indicating an event “a power of an ATM is cut off” from the monitoring service company 7 after receiving information indicating the event “a trespasser exists” from the security company 4, the gateway apparatus 12 can expect that a crime has occurred at a building including the ATM. Accordingly, by storing events occurred at each customer service device in the individual condition/instruction condition management database, the gateway apparatus 12 can judge a regular pattern of the events that has occurred in the past, or a plurality of the events in total, and thus can supply accurate instructions to systems including the security system 13 and the appliance surveillance system 16.

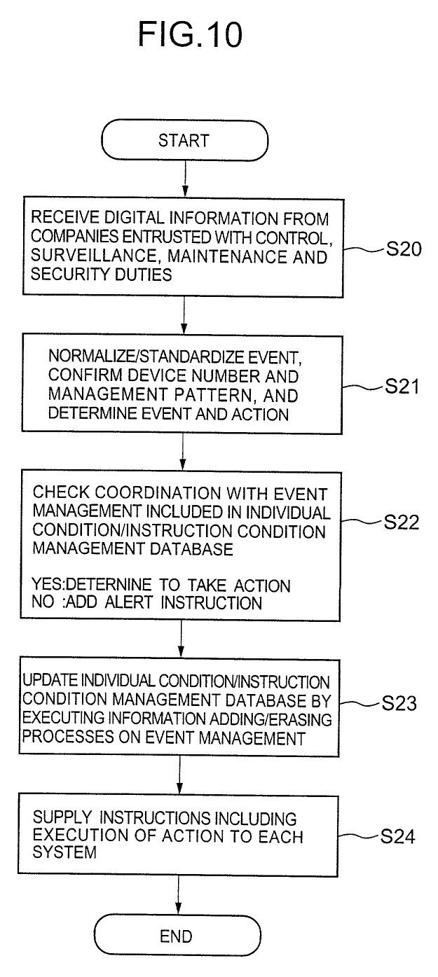

A description will now be given, with reference to a flowchart shown in FIG. 10, of a management process of a customer service device performed by the gateway apparatus 12 by use of the standard pattern database 30 and the individual condition/instruction condition management database. FIG. 10 is a flowchart showing a management process of a customer service device performed by the gateway apparatus 12, according to a fifth embodiment of the present invention.

At a step S20 shown in FIG. 10, the gateway apparatus 12 receives information regarding events, for instance, in a digital information format, from systems such as the control system 11, the security system 13, the maintenance system 14, the appliance maintenance system 15 and the appliance surveillance system 16. For instance, if the security company 4 entrusted with a security duty of the ATMs 10a through 10n has detected an abnormal trespassing on a building in which the ATM 10a is installed, the gateway apparatus 12 is supplied with digital information indicating the event “a trespasser exists” from the security system 13.

At a step S21, the gateway apparatus 12 decides an occurred event by normalizing or standardizing supplied digital information as well as decides a device number and a management pattern, both corresponding to the occurred event by use of the device/management pattern table 31. Subsequently, the gateway apparatus 12 determines an action to be performed by use of the decided management pattern and the decided event in the management pattern/action list table 32. For instance, if having received digital information indicating the event “a trespasser exists” from the security system 13, the gateway apparatus 12 normalizes and standardizes the digital information, and then decides the event code “2033” corresponding to the event “a trespasser exists”. Subsequently, the gateway apparatus 12 decides a management pattern corresponding to the ATM 10a at which the event has occurred, by use of the device/management pattern table 31. The gateway apparatus 12 can select an action that should be performed from the management pattern/action list table 32 by use of the decided management pattern and the event code “2033”.

At a step S22, the gateway apparatus 12 confirms coordination of the event, the device number and the management pattern decided at the step S21 with the event management included in the individual condition/instruction condition management database, based on an individual condition and an instruction condition. The coordination with the event management is confirmed in accordance with conditions such as an event code recorded in the event management, an individual condition of the ATMs 10a through 10n and an instruction condition to each company. If the event, the device number and the management pattern match the event management, the gateway apparatus 12 determines to take the action decided at the step S21. On the other hand, if the event, the device number or the management pattern does not match the event management, or, if there is no coordination between them, the gateway apparatus 12 checks whether there is inconsistency in an event order. Subsequently, if the inconsistency has been detected in the event order, the gateway apparatus 12 adds an alerting instruction to the action that should be performed. If no inconsistency has been detected in the event order, the gateway apparatus 12 assumes that there is the coordination, and determines to take the action decided at the step S21.

At a step S23 shown in FIG. 10, the gateway apparatus 12 caries out information adding/erasing processes on the event management, thereby attempting to update the individual condition/instruction condition management database to include the latest information. Subsequently, at a step S24, the gateway apparatus 12 notifies the security system 13, the maintenance system 14, the appliance maintenance system 15 and the appliance surveillance system 16 about instructions based on the action to be performed.

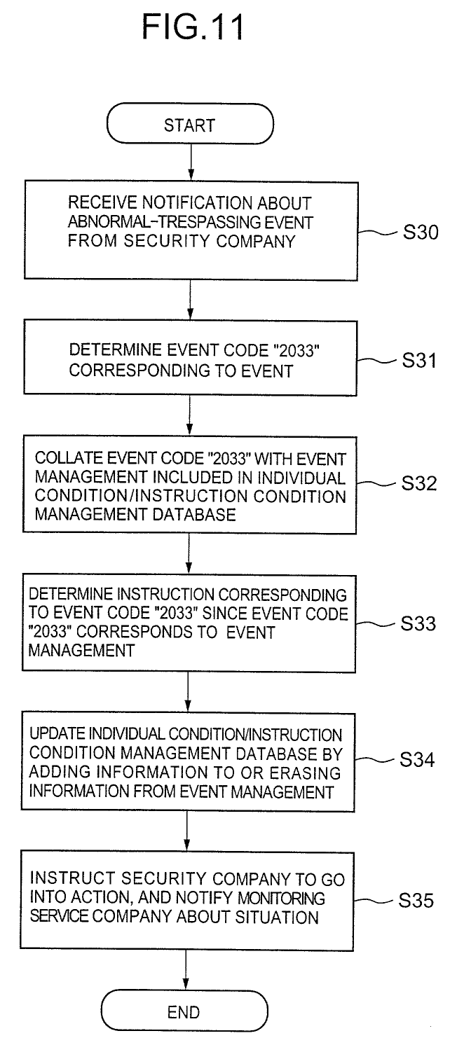

A description will be further given of processes performed by the gateway apparatus 12, with reference to FIGS. 7 through 11. FIG. 11 is a flowchart showing a collective decision process performed by the gateway apparatus 12, according to a sixth embodiment of the present invention.

At a step S30 shown in FIG. 11, the security company 4 entrusted with a security duty of the ATMs 10a through 10n detects an abnormal trespassing on a building in which the ATM 10a is installed. Subsequently, the gateway apparatus 12 receives digital information indicating the event “a trespasser exists” from the security system 13 of the security company 4. At a step S31, the gateway apparatus 12 determines the event code “2033” corresponding to the event “a trespasser exists” by normalizing and standardizing the supplied digital information, and determines the management pattern “001” based on information including the institution code “00X1”, the store number “100”, the branch code “01” and the device number “001” of the ATM 10a at which the event has occurred. Additionally, the gateway apparatus 12 selects, for instance, an action to instruct the security company E from the management pattern/action list table 32 shown in FIG. 8 by using the management pattern “001” and the event code “2033”.

At a step S32, the gateway apparatus 12 confirms coordination (appropriateness) of the event code “2033” determined at the step S31, by collating the event management included in the individual condition/instruction condition management database shown in FIG. 9. At a step S33, the gateway apparatus 12 determines to take the action selected by use of the determined management pattern “001” and the event code “2033” from the management pattern/action list table 32, since the event code “2033” determined at the step S31 matches the event code “2033” of the event management included in the individual condition/instruction condition management database, the event management corresponding to a customer service device regarding the institution code “00X1”, the store number “100”, the branch code “01” and the device number “001”. Subsequently, at a step S34, the gateway apparatus 12 updates the individual condition/instruction condition management database to include the newest information by adding information to or erasing information from the event management. At a step S35, the gateway apparatus 12 instructs systems such as the security system 13 and the appliance surveillance system 16.

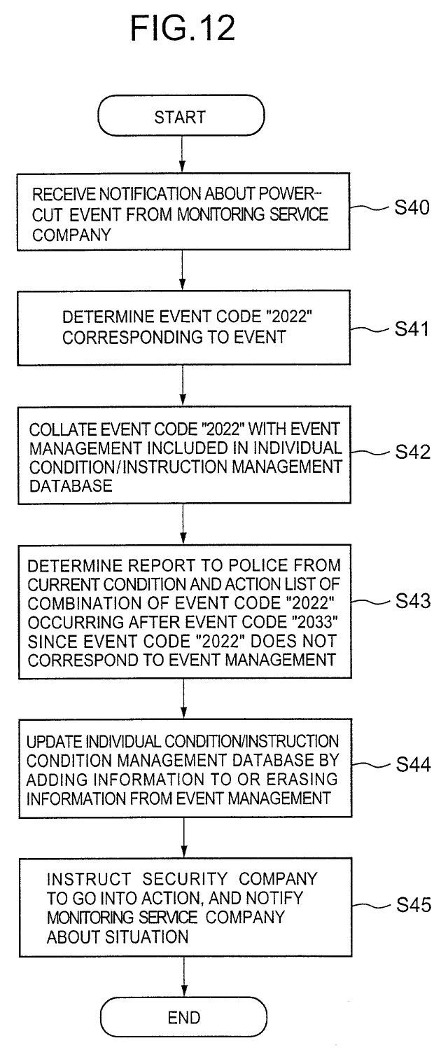

FIG. 12 is a flowchart showing an overall decision process performed by the gateway apparatus 12, according to a seventh embodiment of the present invention. The seventh embodiment describes about a case in which the monitoring service company 7 entrusted with a duty to monitor operating and control conditions of the ATMs 10a through 10n detects a condition that a power of the ATM 10a is cut off.

At a step S40 shown in FIG. 12, the monitoring service company 7 detects the condition in which the power of the ATM 10a is cut off, and supplies digital information indicating an event “a power is cut off” through the appliance surveillance system 16 to the gateway apparatus 12. At a step S41, the gateway apparatus 12 determines the event code “2022” for the event “a power is cut off” by normalizing or standardizing the digital information supplied from the appliance surveillance system 16 as well as determines the management pattern “001” based on information about the ATM 10a including the institution code “00X1”, the store number “100”, the branch code “01” and the device number “001”. Additionally, the gateway apparatus 12 selects actions, for instance, to notify the monitoring service company C and to instruct the system maintenance company D, from the management pattern/action list table 32 shown in FIG. 8 by use of the management pattern “001” and the event code “2022”.

Subsequently, at a step S42, the gateway apparatus 12 collates the event code “2022” determined at the step S41 with the event management included in the individual condition/instruction condition management database shown in FIG. 9, thereby checking correspondence (coordination) of the event code “2022” with the event management. Consequently, at a step S43, the gateway apparatus 12 detects that the event code “2022” determined at the step S41 does not match the event management (the event code “2033”) included in the individual condition/instruction condition management database, the event management corresponding to a customer service device (an ATM) whose institution number, store number, branch code and device number are respectively “00X1”, “100”, “01” and “001”. The gateway apparatus 12 makes an overall decision on the event code “2022” occurring after the event code “2033”, the management pattern/action list table 32 and the determined management pattern “001”, and reports the event to the police as well as determines to take the actions selected at the step S40. At a step S44, The gateway apparatus 12 updates the individual condition/instruction condition management database by performing information adding and erasing processes on the event management. Subsequently, at a step S45, the gateway apparatus 12 supplies instructions based on the actions selected at the step S41 to the security system 13 and the appliance surveillance system 16.

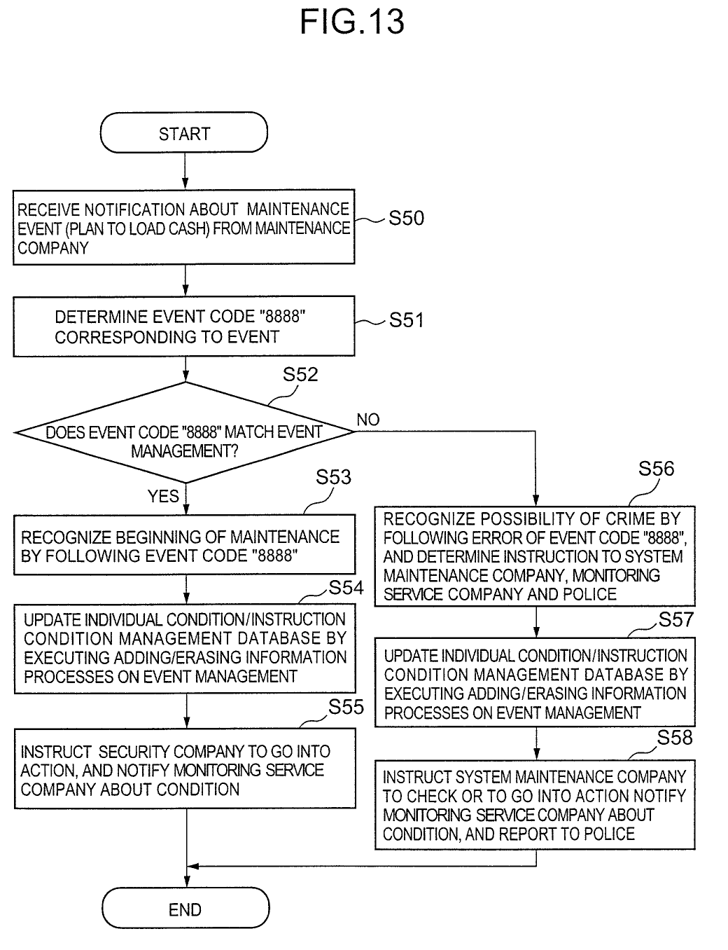

FIG. 13 is a flowchart showing another overall decision process performed by the gateway apparatus 12, according to an eighth embodiment of the present invention. The eighth embodiment describes about a case in which the maintenance company 5 notifies the gateway apparatus 12 about a maintenance plan.

The gateway apparatus 12 receives digital information indicating an event “maintenance of an ATM is planned (cash will be loaded to an ATM)” from the maintenance system 14 of the maintenance company 5, at a step S50 shown in FIG. 13. Subsequently, the gateway apparatus 12 determines an event code “8888” of the event by normalizing or standardizing the digital information received from the maintenance system 14, at a step S51. Additionally, the gateway apparatus 12 determines the management pattern “001” from the institution code “00X1”, the sore number “100”, the branch code “01” and the device number “001” that correspond to the event.

At a step S52, the gateway apparatus 12 collates the event code “8888” with the event management included in the individual condition/instruction condition management database, thereby determining whether the event code “8888” determined at the step S51 matches the event management included in the individual condition/instruction condition management database. If so, the gateway apparatus 12 proceeds to a step S53, and recognizes the beginning of maintenance by following the event code “8888”. Additionally, the gateway apparatus 12 decides to take actions selected from the management pattern/action list table 32 by use of the management pattern “001” and the event code “8888”. At a step S54, the gateway apparatus 12 performs information adding/erasing processes on the event management, thereby updating the individual condition/instruction condition management database. At a step S55, the gateway apparatus 12 gives instructions based on the actions selected at the step S53 to systems such as the security system 13 and the appliance surveillance system 16.

If having determined that the event code “8888” does not match the event management included in the individual condition/instruction condition management database, the gateway apparatus 12 proceeds to a step S56, and recognizes a possibility of a situation in which a crime has occurred, by following an error of the event code “8888”. The gateway apparatus 12, then decides to report the situation to the police as well as decides to take the actions selected from the management pattern/action list table 32 by use of the management pattern “001” and the event code “8888”. Subsequently, at a step S57, the gateway apparatus 12 updates the individual condition/instruction condition management database by adding information to or erasing information from the event management. At a step S58, the gateway apparatus 12 reports occurrence of the crime to the police as well as supplies instructions based on the actions selected at the step S53 to the security system 13, the appliance surveillance system 16, and the like.

As described above, the gateway apparatus 12 according to the present invention is able not only to simply determine information regarding events supplied from systems including the control system 11, the security system 13, the maintenance system 14, the appliance maintenance system 15 and the appliance surveillance system 16, but also to collectively determine a combination of a plurality of events and an order of events to be occurred. Therefore, the gateway apparatus 12 can transmit instructions regarding management of the management system 1 to the systems, based on accurate understanding of a condition of a customer service device.

Additionally, because of managing information regarding the customer service device collectively, the gateway apparatus 12 can supply analyzed or processed information regarding the customer service device to related companies, the information having a high added value. Furthermore, because of collectively managing information regarding customer service devices owned by a plurality of financial institutions, the gateway apparatus 12 can introduce a first customer service device owned by a financial institution to a customer of a second customer service device owned by another financial institution in a case in which a trouble or shortage of cash stored in the second customer service device has occurred.

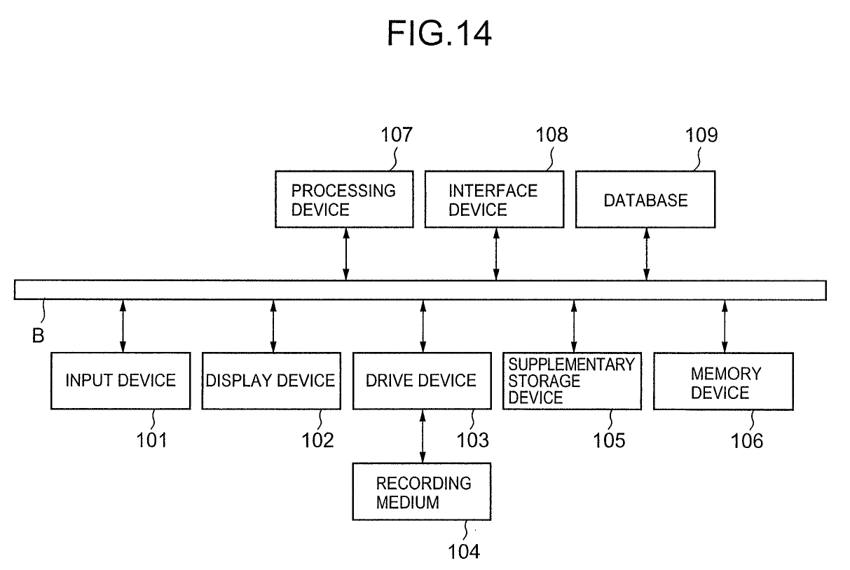

Additionally, the gateway apparatus 12 may have a structure shown in FIG. 14. FIG. 14 is a block diagram showing a structure of a computer system as the gateway apparatus 12, according to a ninth embodiment of the present invention. The computer system shown in FIG. 14 includes an input device 101, a display device 102, a drive device 103, a recording medium 104, a supplementary storage device 105, a memory device 106, a processing device 107, an interface device 108 and a database 109, each being connected by a bus B.

The input device 101 is comprised of, for instance, a keyboard and a mouse operated by a person in charge of the computer system at the management company 3, and is used for inputting various types of operating signals to the computer system. For instance, the person in charge of the computer system at the management company 3 inputs contract management information and customer-service-device management information by using the input device 101, in a case in which the financial institution 2 has provided the contract management information and the customer-service-device management information in a document format to the management company 3 by following an outsourcing contract made between the financial institution 2 and the management company 3. If the contract management information and the customer-service-device management information is presented in data from the financial institution 2, the computer system reads the data from the recording medium 104 such as a floppy disk, or receives the data from the network 17 through the interface device 108.

The display device 102 displays various types of windows and data necessary for operating the computer system. For instance, the person in charge of operating the computer system at the management company 3 uses the display device 102 to display contents of the device/management pattern table 31 and the management pattern/action list table 32, and to check the contents. The interface device 108 is an interface used for connecting the computer system to the network 17, and is, for instance, comprised of a modem. The computer system transmits information regarding a customer service device to or receives the information from the control system 11, the security system 13, the maintenance system 14, the appliance maintenance system 15 and the appliance surveillance system 16 by using the interface device 108.

The database 109 includes various types of data necessary for the computer system such as the customer-service-device management database, the contract management database, the standard pattern database, individual condition/instruction condition management database, the ATM balance information database and the account processing information database. A management program regarding management of the computer system is supplied to the computer system, for example, by use of the recording medium 104. The recording medium 104 storing the management program is set to the drive device 103. Subsequently, the management program is installed in the supplementary storage device 105 through the drive device 103 from the recording medium 104. The supplementary storage device 105 stores the installed management program as well as stores files and data necessary for the computer system.

The memory device 106 reads the management program from the supplementary storage device 105 when the computer system starts up, and stores the management program therein. The processing device 107 carries out processes related to the computer system by following the management program stored in the memory device 106.

According to the present invention, the gateway apparatus 12 as a management device registers management information about each customer service device. The gateway apparatus 12, then creates actions for operating customer service devices, and registers the actions, each action corresponding to a condition of each customer service device. In a case of receiving condition information from the control systems 11 or other systems, the gateway apparatus 12 selects an action corresponding to the condition information to operate a customer service device. Therefore, management of operating the customer service devices can be automated in accordance with condition information, except some part. Consequently, a part of the management that needs human operations may be omitted, thereby achieving accurate information transmission, a decrease in a loss time, and a cost reduction.

Additionally, the management information includes management information about customer service devices (customer-service-device management information) and contract information about an administrator of the customer service devices and assignees of management of the customer service devices. The administrator is, for example, the financial institution 2 The assignees of the management of the customer service devices include the security company 4, the maintenance company 5, the system maintenance company 6, the monitoring service company 7 and the like. By registering the management information about the customer service devices and the contract information, the gateway apparatus 12 can select actions corresponding to the contract information between the administrator and the assignees to operate the customer service devices, thereby enabling outsourcing of the management of the customer service devices.

Additionally, the gateway apparatus 12 can create and register actions for operating the customer service devices for each customer service device, each action corresponding to a condition of the customer service devices, and thus can manage operations of various types of customer service devices. Accordingly, by managing operations of customer service devices administered by a plurality of administrators, a cost of managing the operations can be further reduced than that of managing operations of customer service devices administered by a signal administrator.

The gateway apparatus 12 selects and takes an action corresponding to a result of judging one or plurality of condition information totally among registered actions, in a case in which the gateway apparatus 12 has received the one or the plurality of condition information, the condition information corresponding to a condition of a customer service device. As described above, by judging the one or the plurality of condition information totally, the gateway apparatus 12 can select and take the action based on accurate understanding of the condition of the customer service device.

Additionally, the condition information and identification information about a customer service device taking an operating action according to the condition information is registered as history information. The gateway apparatus 12 selects and takes an action corresponding to the history information and the condition information among registered actions. Accordingly, the gateway apparatus 12 can select and take an action based on accurate understanding of conditions of customer service devices, by taking analysis on the history information into an account for selecting and taking the action.

The above description is provided in order to enable any person skilled in the art to make and use the invention and sets forth the best mode contemplated by the inventors of carrying out the invention.

The present invention is not limited to the specially disclosed embodiments and variations, and modifications may be made without departing from the scope and spirit of the invention.

The present application is based on Japanese Priority Application No. 2000-297132, filed on Sep. 28, 2000, the entire contents of which are hereby incorporated by reference.

What is claimed is:

1. A method of collectively managing management information about a plurality of customer service devices, and managing operations of said plurality of customer service devices based on said management information, said method comprising the steps of:
(a) registering said management information;
(b) creating a plurality of actions to operate each customer service device, based on said management information, each action corresponding to a condition of said each customer service device;
(c) registering said plurality of actions;
(d) selecting an action in accordance with supplied condition information corresponding to the condition of said each customer service device; and
(e) taking said action with respect to said each customer service device.

2. The method as claimed in claim 1, wherein said management information registered at the step (a) includes management information regarding said each customer service device, and contract information about an administrator of said each customer service device and an assignee of management of said each customer service device.

3. The method as claimed in claim 1, wherein the step (b) comprises the step of creating the action corresponding to each condition of said each customer service device.

4. The method as claimed in claim 3, wherein the step (c) comprises the step of registering the action for said each condition of said each customer service device.

5. The method as claimed in claim 1, wherein the step (d) comprises the steps of:
selecting a customer service device corresponding to said supplied condition information among said plurality of customer service devices; and.
selecting the action corresponding to said supplied condition information among said plurality of actions registered at the step (c) for the customer service device.

6. The method as claimed in claim 1, wherein the step (d) comprises the steps of:
judging one or a plurality of types of the condition information totally; and
selecting the action corresponding to a result of judging the one or the plurality of types of the condition information totally, among said plurality of actions registered at the step (c).

7. The method as claimed in claim 1, wherein the step (d) comprises the steps of:
registering said supplied condition information and identification information about a 10 customer service device taking the action according to said supplied condition information, as history information; and
selecting the action corresponding to said history information and said condition information 15 among said plurality of actions registered at the step (c).

8. The method as claimed in claim 1, further comprising the steps of:
instructing a maintainer of said plurality of customer service devices to perform a maintenance operation according to said condition information; and
receiving information about a result of the maintenance operation from the maintainer.

9. The method as claimed in claim 1, wherein said condition information is supplied from one of an administrator and a maintainer of said each customer service device.

10. A management device collectively managing management information about a plurality of customer service devices, and managing operations of said plurality of customer service devices based on said management information, said management device comprising:
an information registering unit registering said management information;
an action creating/registering unit creating a plurality of actions to operate each customer service device, and registering said plurality of actions, based on said management information, each action corresponding to a condition of said each customer service device; and
an action selecting/executing unit selecting an action in accordance with supplied condition information corresponding to the condition of said each customer service device, and taking said action with respect to said each customer service device.

11. A recording medium readable by a management device, tangible embodying a program of instructions executable by said management device to collectively manage management information about a plurality of customer service devices, and manage operations of said plurality of customer service devices based on said management information, said program including the steps of:
registering said management information;
creating a plurality of actions to operate each customer service device, based on said management information, each action corresponding to a condition of said each customer service device;
registering said plurality of actions;
selecting an action in accordance with supplied condition information corresponding to the condition of said each customer service device; and
taking said action with respect to said each customer service device.

12. A management system, comprising:
a customer service device;
an administrative system administering said customer service device;
a maintenance system maintaining said customer service device; and
a management device connected to said customer service device, said administrative system and said maintenance system through a network,
wherein said management device includes an information registering unit registering management information about said customer service device supplied from said administrative system; an action creating/registering unit creating a plurality of actions to operate said customer service device, and registering said plurality of actions, based on said management information, each action corresponding to each condition of said customer service device; and an action selecting/executing unit selecting an action in accordance with condition information corresponding to a condition of the customer service device, and taking said action with respect to the customer service device, said condition information being supplied from said administrative system and said maintenance system.
